(19) United States
(12) Patent Application Publication
(10) Pub. No.: US 2013/0265332 A1
(43) Pub. Date: Oct. 10, 2013

(54) INFORMATION PROCESSING APPARATUS, CONTROL METHOD OF INFORMATION PROCESSING APPARATUS, AND STORAGE MEDIUM STORING PROGRAM

(71) Applicant: CANON KABUSHIKI KAISHA, Tokyo (JP)

(72) Inventor: Takumi Miyakawa, Yokohama-shi (JP)

(21) Appl. No.: 13/857,788

(22) Filed: Apr. 5, 2013

(30) Foreign Application Priority Data
Apr. 10, 2012 (JP) 2012-089553

(51) Int. Cl. G06T 19/00

(52) U.S. Cl. CPC G06T 19/006
USPC 345/633

(57) ABSTRACT

An information processing apparatus includes an identifier obtaining unit configured to obtain an identifier of another apparatus, a detection unit configured to detect a predetermined object from a captured image, a feature-information obtaining unit configured, based on the obtaining identifier, to obtain feature information for specifying the predetermined object, a specifying unit configured, based on the characteristic information, to perform specifying processing for specifying the predetermined object detected by the detection unit, and a control unit configured, depending on a result of the specifying processing, to perform control not to obtain the identifier by the identifier obtaining unit.

### BACKGROUND OF THE INVENTION

1. Field of the Invention

The present invention relates to an information processing apparatus for specifying an object from a captured image.

2. Description of the Related Art

In recent years, there has been developed an augmented reality (AR) technique for displaying an image captured by a camera and combined with attribute information about an object in the captured image. For example, based on location information by a global positioning system (GPS), the image is combined with the attribute information about the object in the captured image and displayed.

Further, Japanese Patent Application Laid-Open No. 2002-305717 discusses a technique for, based on feature information used for identification obtained from a mobile terminal owned by the object person, specifying an object person in the captured image, obtaining the attribute information about the specified person from a server, and displaying the information near the specified object in the captured image.

As a technique for collecting the information from such a mobile terminal, Japanese Patent Application Laid-Open No. 2006-031419 discusses a method in which a tag reader provided in a network camera collects object information about the object from a tag owned by the object. According to Japanese Patent Application Laid-Open No. 2006-031419, the tag reader starts to collect tag information by an instruction, as trigger, for information collection from a user. Further, Japanese Patent Application Laid-Open No. 2007-228195 discusses a technique for capturing the image by a camera whose angle of view is associated with an area of a directional antenna, when the object having a radio frequency (RF) tag passes the area of the directional antenna. According to Japanese Patent Application Laid-Open No. 2006-031419, information indicating presence of the object, which is an owner of the RF tag, in the captured image is appended to the image.

However, the conventional technique has no considerations about effectively using communication resources and reducing processing load when the information is collected from the mobile terminal, and thus has room for improvement. For example, according to the conventional technique, the information collection processing is performed without considerations about whether the information has been already collected from the mobile terminal included within an enabled communication area. As described above, if the communication is to be performed with the mobile terminal from which the information has been already collected, unnecessary power is consumed in an unnecessary communication band, thereby deteriorating efficiency.

### SUMMARY OF THE INVENTION

According to an aspect of the present invention, an information processing apparatus includes an identifier obtaining unit configured to obtain an identifier of another apparatus, a detection unit configured to detect a predetermined object from a captured image, a feature-information obtaining unit configured, based on the obtained identifier, to obtain feature information for specifying the predetermined object, a specifying unit configured, based on the feature information, to perform specifying processing for specifying the predetermined object detected by the detection unit, and a control unit configured, depending on a result of the specifying processing, to perform control not to obtain the identifier by the identifier obtaining unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates a configuration of an AR system.

FIG. 2 illustrates an example of information retained in a database managed by a server 109.

FIG. 3 is a block diagram illustrating a functional configuration of a camera 101.

FIG. 4 illustrates a configuration of a mobile phone.

FIG. 5 illustrates an example of a message sequences among apparatuses in an AR system.

FIG. 6 illustrates an example of identification information (identifier).

FIG. 7 is a flowchart illustrating specifying processing.

FIG. 8 is a flowchart illustrating determination processing.

FIG. 9 illustrates an example of an object table.

FIG. 10 illustrates another example of the object table.

FIG. 11 illustrates an example of a probe request frame.

FIGS. 12A, 12B, 12C, and 12D illustrate examples of display screens of the camera 101.

FIG. 13 illustrates a hardware configuration of the camera 101.

FIG. 14, which is composed of FIGS. 14A and 14B, is a flowchart illustrating an entire movement of the camera 101.

### DESCRIPTION OF THE EMBODIMENTS

Various exemplary embodiments, features, and aspects of the invention will be described in detail below with reference to the drawings.

The exemplary embodiment described below is directed to control not to obtain an identifier of another apparatus according to specification of an object detected from a captured image.

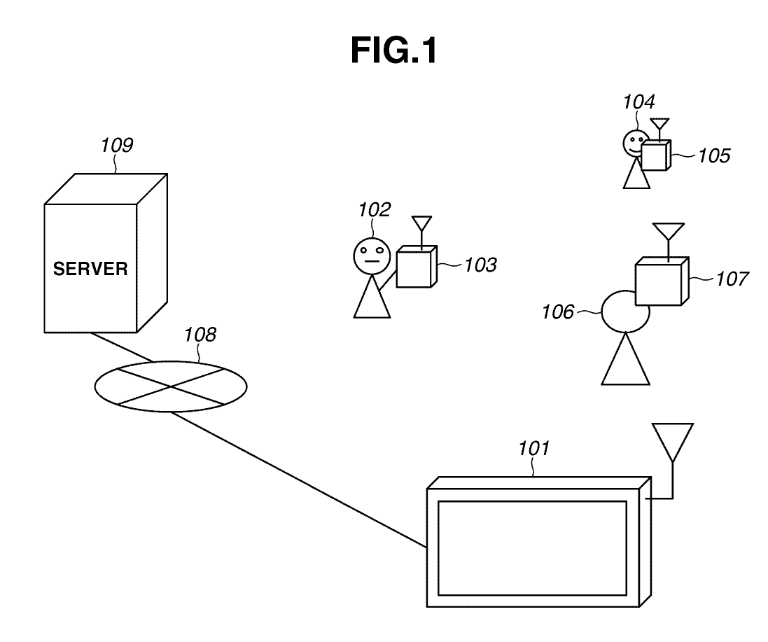

According to the present exemplary embodiment, a camera apparatus that displays additional attribute information about the object in an image captured by the camera will be described. With reference to diagrams, each exemplary embodiment according to the present invention will be described. FIG. 1 illustrates a configuration of an AR system according to the present exemplary embodiment. A camera 101 is an information processing apparatus capturing a digital image.

The camera 101 obtains from a server 109 the attribute information that is received from another terminal apparatus and associated with identification information (identifier) by which a terminal apparatus can be uniquely identified, combines the obtained attribute information with the captured image, and then displays the combined image on a display unit. Further, the camera 101 specifies the object from the captured image, based on feature information associated with the identification information. The specified object and the attribute information are associated and combined with each other, and displayed on the display unit.

The camera 101 has a wireless local area network (LAN) communication function compliant with the Institute of Electrical and Electronic Engineers (IEEE) 802.11 series. FIG. 1 does not illustrate an owner of the camera 101. In an imaging range of the camera 101, persons 102, 104 and 106 present.

Mobile phones 103, 105, and 107 are terminal apparatuses transmitting as the identification information the identifier that can uniquely identify the terminal periodically or in response to a request from the another terminal. As the identification information, the information may uniquely identify a user of the terminal apparatus, or may be the feature information and attribute information about the user. The mobile phones 103, 105, and 107 have a wireless LAN communication function compliant with the IEEE802.11 series. The identification information is appended as one of the elements of the frame compliant with the IEEE802.11 series and transmitted.

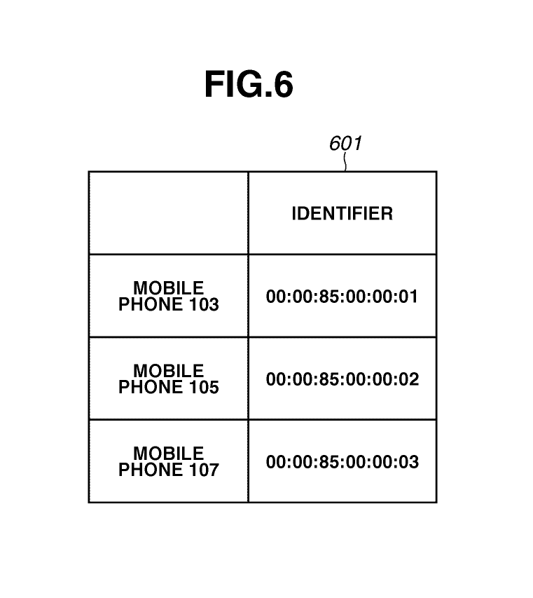

FIG. 6 illustrates an example of the identification information transmitted by the mobile phones 103, 105, and 107. The owner of the terminal can be uniquely identified based on the identification information. The identification information is, for example, a media access control (MAC) address or user identification (ID) of the owner of the terminal apparatus as the identifier being capable of uniquely identifying the terminal apparatus. The owners of the mobile phones 103, 105, and 107 refer to the persons 102, 104, and 106.

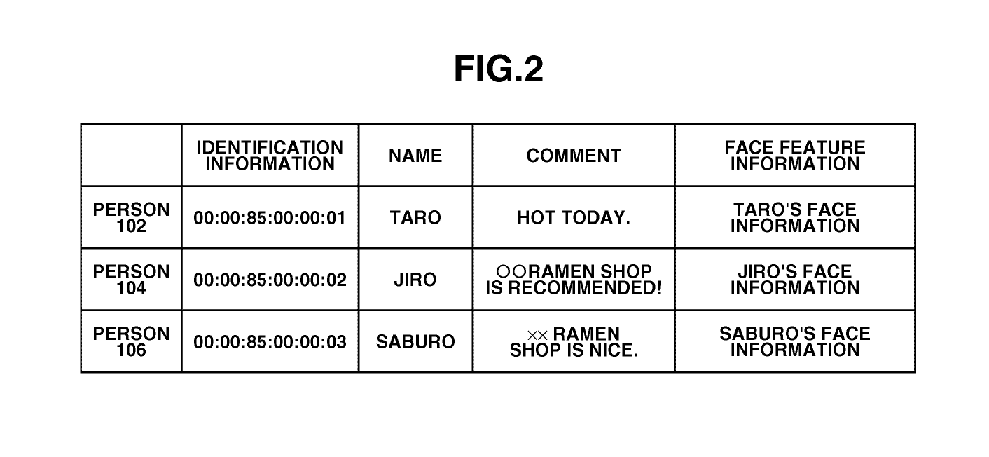

The server 109 searches from a database the feature information and the attribute information associated with the identification information received from the camera 101, and then transmits the information to the camera 101 via a network 108. FIG. 2 illustrates an example of information retained in the database managed by the server 109. The database retains the identification information for uniquely identifying the terminal apparatus as the identifier, a name of the owner of the terminal apparatus, a comment, and the feature information that are associated with one another as the attribute information.

The feature information detects the object associated with the identification information from the captured image and specifies it. According to the present exemplary embodiment, a reference image for performing object specifying processing by image processing is defined as the feature information. As the feature information, in addition to image data, arbitrary feature information used for the object specifying processing may be used. According to the present exemplary embodiment, as the feature information, face images of the persons 102, 104, and 106 are stored in the database.

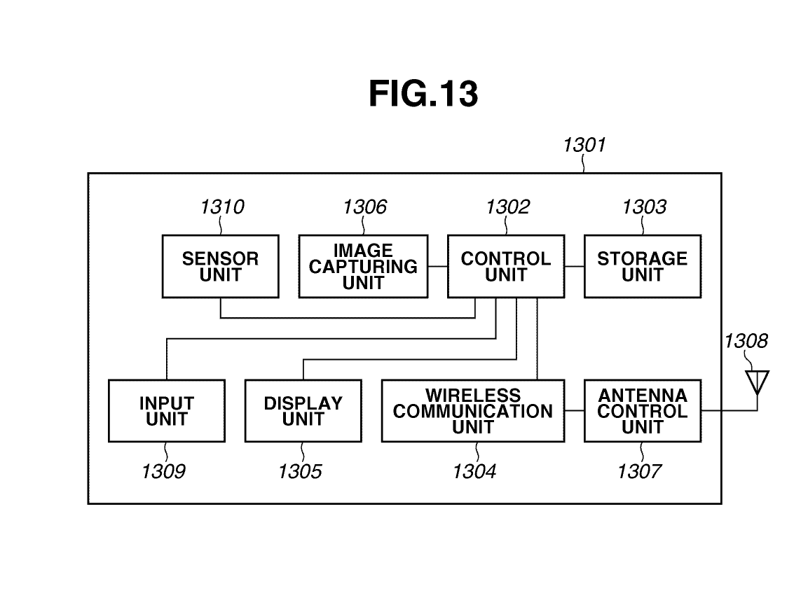

Subsequently, a configuration of the camera 101 will be described. FIG. 13 illustrates a hardware configuration of the camera 101. 1301 indicates an entire apparatus. A control unit 1302 controls the entire apparatus by executing a control program stored in a storage unit 1303. The storage unit 1303 stores the control program to be executed by the control unit 1302 and various types of information. Various types of operations described below are performed by the control unit 1302 executing the control program stored in the storage unit 1303. A wireless communication unit 1304 performs the wireless LAN communication compliant with the IEEE802.11 series. A display unit 1305 performs various types of display and has functions of outputting information that can be visually identified such as a liquid crystal display (LCD) and a light-emitting diode (LED) or that can output audio such as a speaker. An image-capturing unit 1306 captures light of the object entered via a lens as an image. An antenna control unit 1307 controls an antenna 1308. An input unit 1309 is used by the user to perform various types of inputs. A sensor unit 1310 includes an acceleration sensor obtaining acceleration in three axes directions and a GPS sensor obtaining location information.

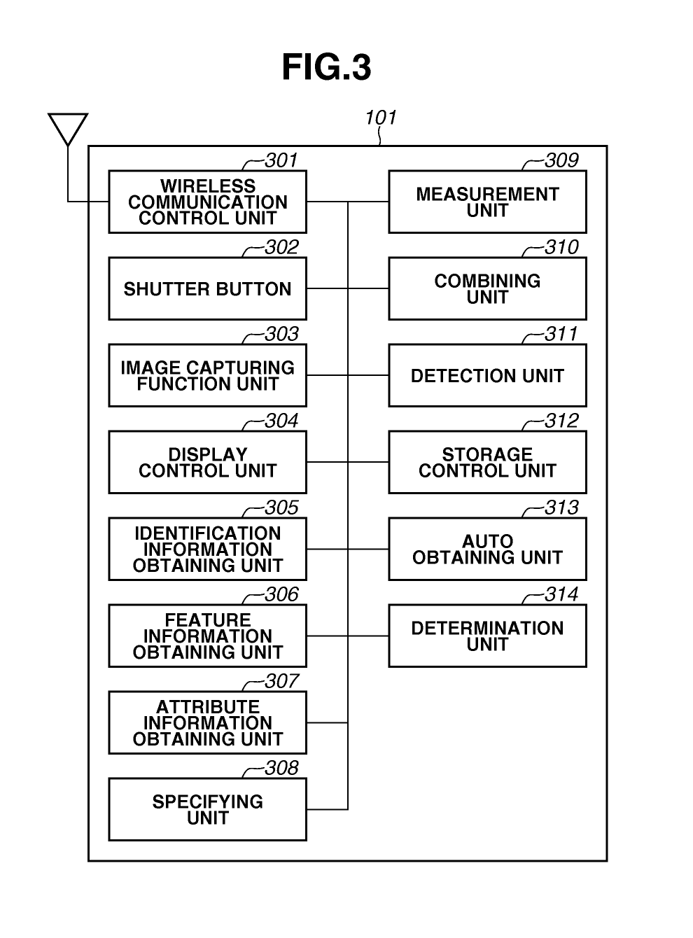

FIG. 3 is a block diagram illustrating a functional configuration realized by the control unit 1302 of the camera 101 performing an operation process of the information and controlling each hardware. A part of or entire functional configuration illustrated in FIG. 3 may be realized as the hardware. A wireless-communication control unit 301 controls the antenna 1308 and the wireless communication unit 1304 to control the wireless communication to transmit/receive wireless signals to/from another wireless apparatus.

A shutter button 302 is used to start to capture the images, and the image-capturing unit 1306 starts an operation by the user pressing the shutter button 302. Further, the shutter button 302 starts an image-capturing preparation operation when detecting an input of half pressing by the user. An image-capturing function unit 303 controls the image-capturing unit 1306 (lens and red, green and blue (RGB) sensor) to generate image data. A display control unit 304 controls the display for displaying the captured image and various types of information on the display unit 1305.

An identification-information obtaining unit 305 obtains the identification information that is received by the wireless-communication control unit 301 and is about the terminal apparatus existing within an enabled communication area. A feature-information obtaining unit 306 inquires of the server 109 based on the identification information obtained by the identification-information obtaining unit 305, and obtains the feature information associated with the identification information from the server 109. An attribute-information obtaining unit 307 inquires of the server 109 based on the identification information obtained by the identification-information obtaining unit 305, and obtains the attribute information associated with the identification information from the server 109.

A specifying unit 308 detects the object specified by the feature information from the captured image data. A measurement unit 309 obtains movement information about the camera 101 based on output information from a sensor unit 1310 to measure a movement of the camera 101. A combining unit 310 combines the attribute information associated with the specified object obtained by the attribute-information obtaining unit 307 near the object specified by the specifying unit 308 or at an arbitrary position to generate combined image data.

A detection unit 311 detects a predetermined object from the image data obtained from the image-capturing function unit 303 using a known object detection technique. The predetermined object refers to a human's face for example. Further, the detection unit 311 extracts edge information from the image, separates an arbitrary object from background of the captured image by image processing such as pattern matching to identify them.

A storage control unit 312 controls an input/output of the information into/from the storage unit 1303. An auto-obtaining unit 313 causes the identification-information obtaining unit 305 to automatically operate even in a state where the shutter button 302 is not pressed, for example, when a moving image is captured. The auto-obtaining unit 313 notifies the identification-information obtaining unit 305 of a request for obtaining the identification information every predetermined period (e.g., every five seconds) or depending on whether the camera 101 has moved by a predetermined threshold value or more. Alternatively, depending on whether the image (hereinafter, referred to as a “through-the-lens image”) periodically obtained by the image-capturing unit 1306 has changed by a predetermined threshold value or more, the auto-obtaining unit 313 notifies the identification-information obtaining unit 305 of the request for obtaining the identification information. When the auto-obtaining unit 313 has never obtained the identification information after the power of the camera 101 is turned on, the auto-obtaining unit 313 notifies the identification-information obtaining unit 305 of the obtaining request, and then subsequently notifies a determination unit 314 thereof. The determination unit 314 determines whether to cause the identification-information obtaining unit 305 to perform identification obtaining processing. The through-the-lens image refers to the image to be sequentially captured in a predetermined frame rate. Further, the through-the-lens image is not directed to be recorded into a storage medium such as a memory card but to be a moving image to make the user recognize a state of the object.

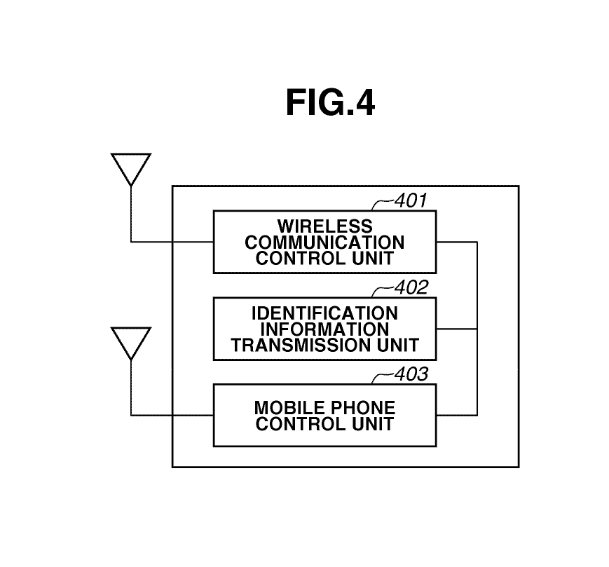

Subsequently, the configurations of the mobile phones 103, 105, and 107 will be described. Each mobile phone includes a central processing unit (CPU). Each configuration described below can be realized by the CPU executing the control program to perform the operation and processing of the information and control of each hardware. As illustrated in FIG. 4, a wireless-communication control unit 401 controls the antenna and a circuit for transmitting/receiving the wireless signals to/from another wireless apparatus via the wireless LAN. An identification-information transmission unit 402 controls the wireless-communication control unit 401 to notify the wireless-communication control unit 401 of the retaining identification information (identifier) periodically or in response to the request from the another apparatus. The identification-information transmission unit 402 append and transmits the identification information (identifier) as one of information elements of the beacon frame compliant with IEEE802.11. A mobile-phone control unit 403 controls the antenna and the circuit for causing the mobile phone to operate to connect with a mobile phone communication network, and then performs the communication with the another apparatus.

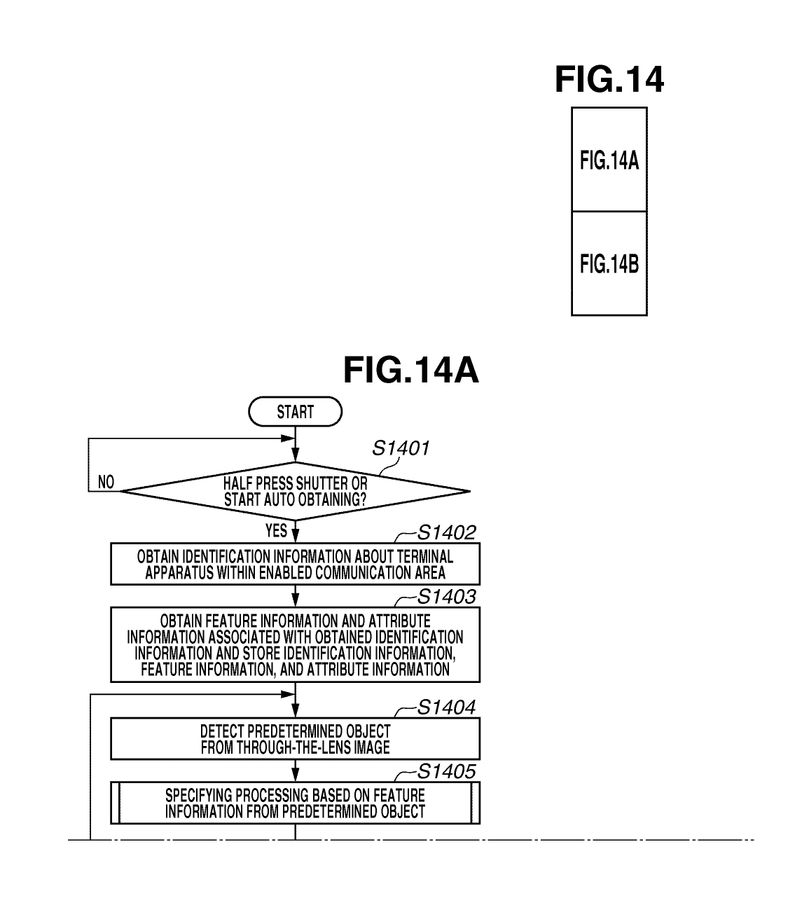

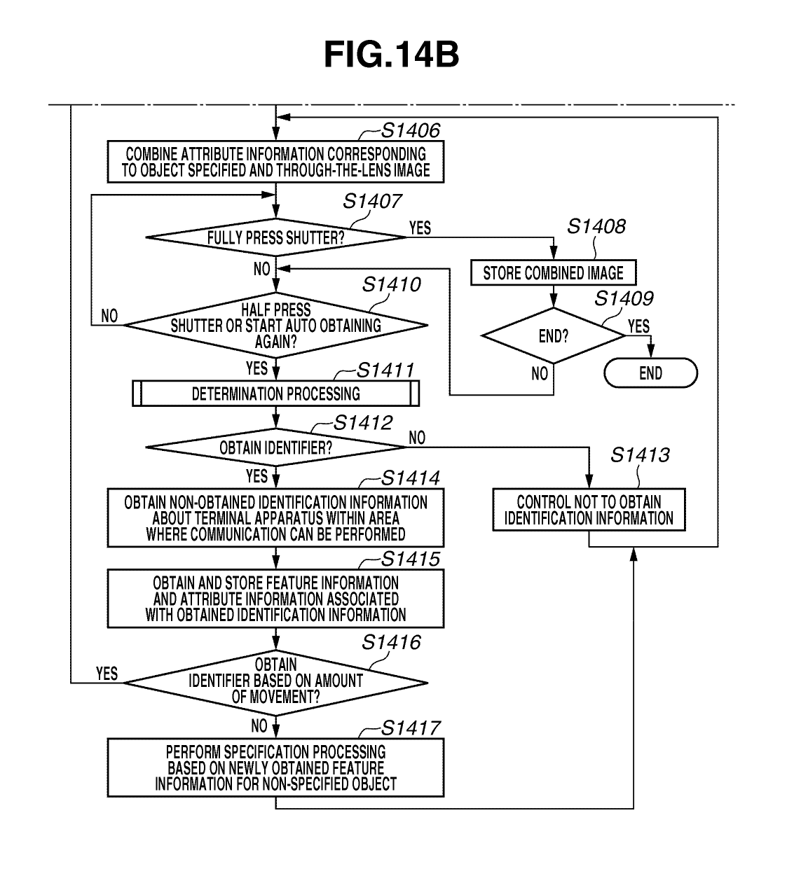

An operation of a system according to the present exemplary embodiment including the above-described configuration will be described. FIG. 14, which is composed of FIGS. 14A and 14B, is a flowchart illustrating an entire operation of the camera 101. The flowchart illustrated in FIG. 14 can be realized by the control unit 1302 executing the control program read from the storage unit 1303. When the power of the camera 101 is turned on, the processing is started. In step S1401, the camera 101 determines whether the detection of a shutter button 302 being half pressed, which indicates an instruction for preparing to capture the images, or the first acquisition request by the auto-obtaining unit 313 is notified to the identification-information obtaining unit 305. When the detection of the shutter button 302 being half pressed or the first identifier obtaining request by the auto-obtaining unit 313 is notified to the identification-information obtaining unit 305 (YES in step S1401), then in step S1402, the identification-information obtaining unit 305 obtains the identification information about the terminal apparatus within the enabled communication area. The identification-information obtaining unit 305 controls the wireless-communication control unit 301 to transmit a probe request frame (probe request) and obtains the identification information included in a response (probe response) from the terminal apparatus within the enabled communication area.

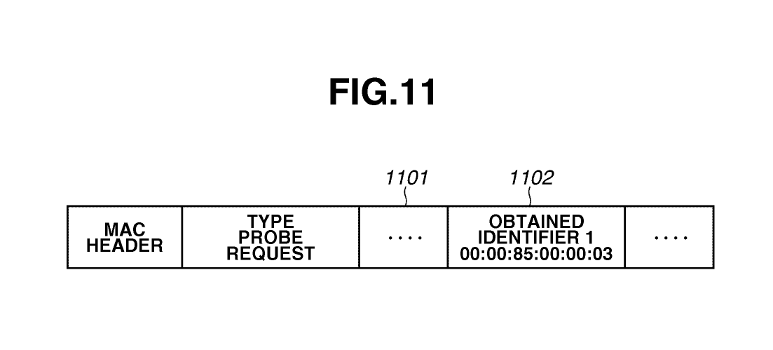

The probe request frame according to the present exemplary embodiment illustrated in FIG. 11 will be described below. A probe-request frame 1101 uses a probe request frame that is a control packet prescribed under the IEEE802.11 series. Arbitrary information can be added in data region 1102 in the frame. The probe request frame can be also referred to as a transmission request (identifier request) message for requesting the terminal apparatus existing within the enabled communication area to transmit the identifier to the camera 101.

Subsequently, the feature-information obtaining unit 306 and the attribute-information obtaining unit 307 inquire of the server 109 to obtain the feature information and the attribute information associated with the obtained identification information. When the server 109 receives the inquiry from the camera 101, the server 109 obtains the attribute information and the feature information associated with the identification information from the data base based on the identification information included in the inquiry, and transmits the attribute information and the feature information to the camera 101. In step S1403, the feature-information obtaining unit 306 and the attribute-information obtaining unit 307 obtain the characteristic information and the attribute information transmitted from the server 109. The storage control unit 312 stores in the storage unit 1303 the identification information, the feature information, and the attribute information that are associated with one another. As described above, the camera 101 holds the obtained identification information, the characteristic information, and the attribute information.

In step S1404, the detection unit 311 detects the predetermined object from the through-the-lens image captured by the image-capturing function unit 303. The predetermined object refers to, for example, a human's face, and the detection unit 311 detects a region of the human's face from the through-the-lens image periodically captured by the image-capturing function unit 303. Further, the information about the detected object is input into the object table described below. In step S1405, the specifying unit 308 performs specifying processing based on the feature information from the predetermined object.

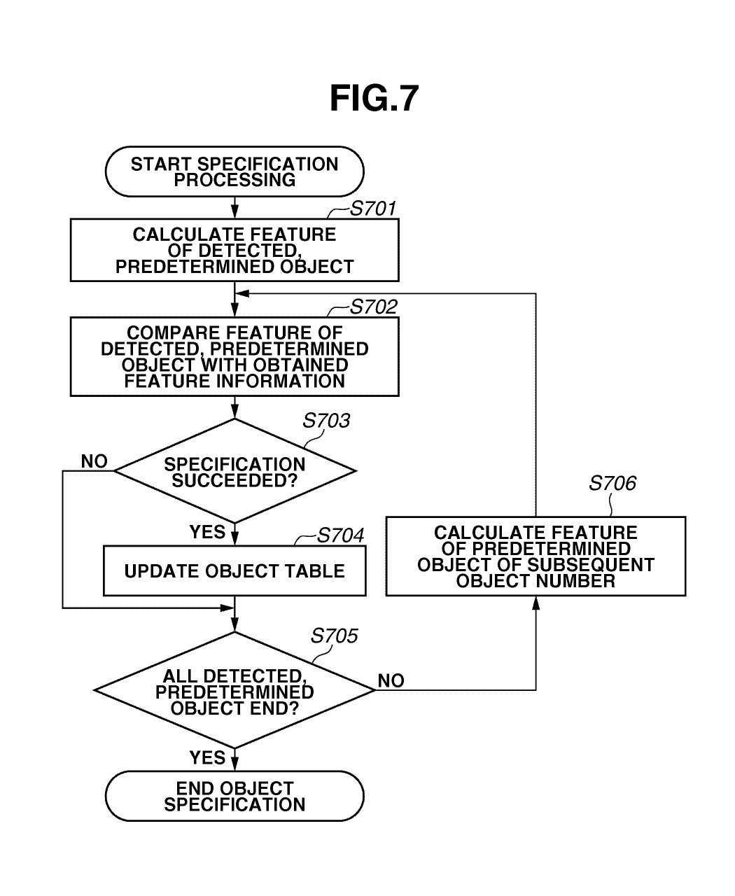

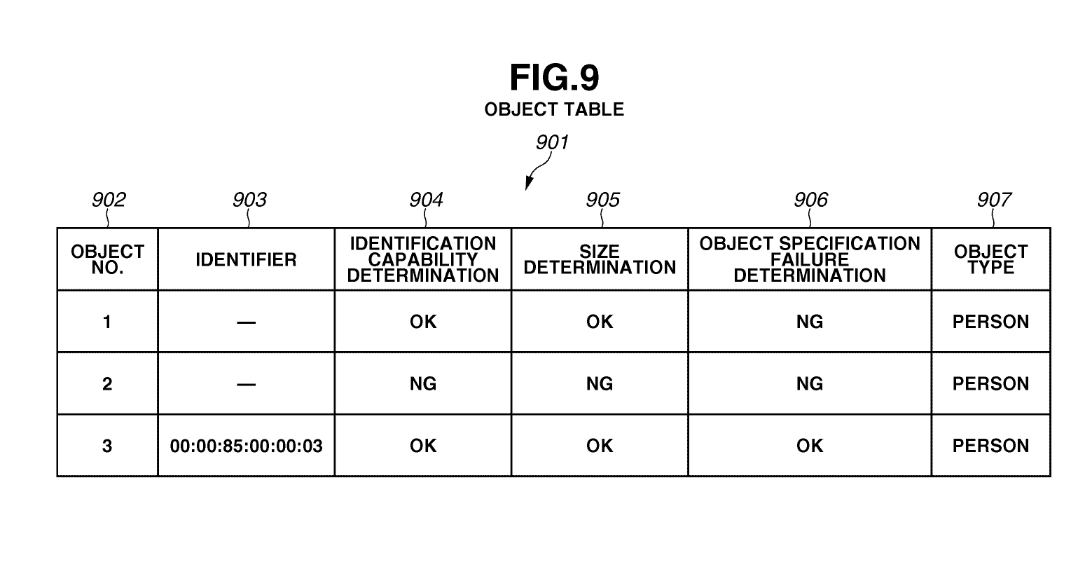

FIG. 7 illustrates details of the specifying processing performed in step S1405. Based on the obtained feature information, the specifying processing determines whether the predetermined object detected by the detection unit 311 is the object based on the feature information. In other words, the specifying processing is the process for specifying the person from the faces in the image. In step S701, the specifying unit 308 calculates the feature of the image information about the predetermined object detected by the detection unit 311. The feature of the predetermined object calculated in step S701 belongs to the object corresponding to an object number “1” in the object table described below. In step S702, the specifying unit 308 compares the feature of the object calculated in step S701 with the obtained feature information. In step S703, the specifying unit 308 determines whether a correlation between the feature of the object calculated by comparison performed in step S702 with the obtained feature information exceeds a threshold value and whether an individual person can be specified. If the detection unit 311 can specify the individual person from the object detected by the detection unit 311 based on the feature information (YES in step S703), the processing proceeds to step S704. If the individual person cannot be specified from the detected object based on the feature information (NO in step S703), the processing proceeds to step S705. If the object is successfully specified, then in step S704, the specifying unit 308 updates the object table subsequently. With reference to FIG. 9, the object table to be updated by the specifying unit 308 will be described.

The object table classifies states of specification of the predetermined object detected from the captured image. An object number 902 for identifying the object is appended for each predetermined object detected by the detection unit 311 from the captured image, and stored in the object table 901. If it is specified that the detected, predetermined object is the object based on the feature information obtained by the specifying unit 308, the identification information corresponding to a column of an identifier 903 of the corresponding object table is stored. If the object is not specified, the information is not stored in the column of the identifier 903.

Further, the object table 901 stores a result of determination of whether the region (image size) on the image corresponding to each object detected by the detection unit 311 is sufficiently large to perform the specifying processing by the specifying unit 308. If the result of the size determination 905 in the object table 901 indicates that the region on the image corresponding to the object is sufficiently large to perform the specifying processing, “OK” is stored. If the result indicates that the region thereon is not sufficiently large to perform the specifying processing, “NG” is stored. Further, in the update object table (step S704), with respect to the specified object, the corresponding identifier is stored in the column of the identifier 903 of the corresponding object No. of the object table 901. Furthermore, a column of an object-specification failure determination 906 stores the result of the specifying processing performed by the specifying unit 308. If the specifying processing is successfully performed, “OK” is stored. If the specifying processing is failed, “NG” is stored. An object type 907 stores a type of the detected object including a “person”, a “dog”, and a “vehicle”.

An identifiability determination 904 stores a result of determination of a state where each object can be specified. A state of identifiability refers to a state where the size determination 905 indicates “OK” and the object type 907 indicates the “person”. The identifiability determination 904 stores “OK” if the object is identifiable. The identifiability determination 904 stores “NG” if the object is not identifiable.

If the object table is updated, or if, in step S703, it is determined that specification of the object has been failed as described above, the specifying unit 308 determines whether the processing has been performed on all of the detected, predetermined objects. If the processing has been performed on all of the detected, predetermined objects (YES, in step S705), the specifying processing ends. In step S706, if the processing has not been performed on all of the detected, predetermined objects (NO, in step S705), the feature of the predetermined object of the subsequent number is calculated, and then the processing returns to step S702.

Returning to FIG. 14, in step S1406, the combining unit 310 combines the attribute information (name and comment) and the through-the-lens image in association with the object specified by the specifying unit 308 near the object. The display control unit 304 performs control to display the combined image. The object specified by the specifying unit 308 can be referred to as the object in which the information is displayed in association with the object. The attribute information may be continuously displayed through a plurality of through-the-lens images while the object specified using object tracking processing is being continuously detected.

In step S1407, subsequently, the camera 101 determines whether full press of the shutter button 302 is detected. If the full press of the shutter button 302 is detected (YES in step S1407), then in step S1408, the storage control unit 312 stores the combined image. In step S1409, the camera 101 determines whether to end the processing based on, for example, the detection of the user's instruction for turning the power off and the detection of the instruction for switching an operation mode (switching to an image browsing mode). If the processing does not end (NO in step S1409), or if the full press of the shutter button 302 is not detected in step S1407 (NO in step S1407), the processing proceeds to step S1410. The processing in step S1409 may be performed at arbitrary timing as interruption processing.

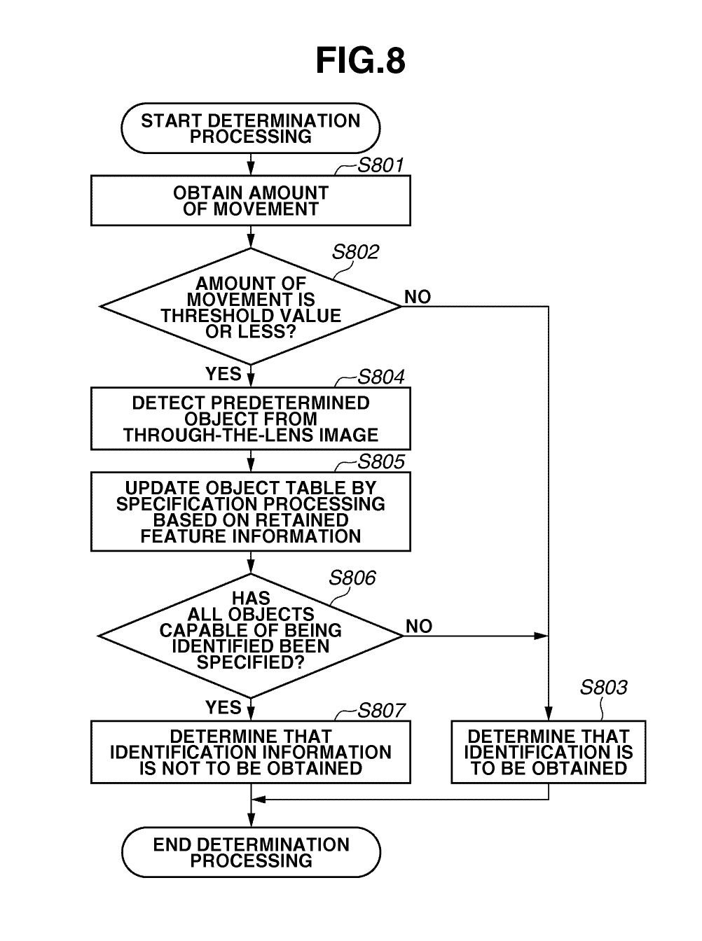

In step S1410, the camera 101 determines whether the shutter button 302 being pressed (half press) has been detected again or whether the auto-obtaining unit 313 has notified the identifier obtaining request. If it is not determined that the shutter button 302 being pressed (half press) has been detected again or the identifier obtaining request has been notified by the auto-acquisition unit 313 (NO in step S1410), the processing returns to step S1407. If it is determined (YES in step S1410), the processing proceeds to step S1411. If the processing of step S1402 has been already performed, the auto-obtaining unit 313 notifies the determination unit 314 of the identifier obtaining request. In step S1411, the determination unit 314 determines whether to obtain the identification information based on the specifying state of the object in the captured image so as not to collect unnecessary identification information. With reference to the flowchart illustrated in FIG. 8, the determination processing in step S1411 will be described in detail.

As illustrated in FIG. 8, in step S801, the measurement unit 309 obtains a motion amount of the camera 101 since the specifying unit 308 has performed the specifying processing previous time to the present, and notifies the determination unit 314 of the motion amount. In step S802, the determination unit 314 determines whether the motion amount of the camera is equal to or more than a predetermined threshold value. If the motion amount equal to or more than the threshold value is detected (NO in step S802), then in step S803, it is considered that an imaging range where the image-capturing function unit 303 captures the image is changed and the object has been changed, so that it is determined to obtain the identification information. This is because the camera having large motion amount can capture a new object, and thus the identification information about surrounding terminal apparatuses needs to be entirely obtained for specifying the new object. The determination unit 314 may determine whether to obtain the identification information based on the motion amount of the camera per a unit time during the processing in step S801. Further, based on difference (amount of change) among image information about the image periodically captured by the image-capturing function unit 303, whether the image capturing area has been changed may be determined, and then whether to obtain the identification information may be determined.

If the motion amount of the camera 101 is equal to or less than the predetermined threshold value (YES in step S802), the processing proceeds to step S804. Similarly to step S1404 described above, the detection unit 311 performs the detection processing of the predetermined object from the through-the-lens image captured most recently. The detection unit 311 updates the object table 901, for example, newly detected object is added to the object table 901, and an object that is not detected is deleted from the table 901.

In step S805, based on the feature information stored and retained by the storage control unit 312, similarly to step S1405, the specifying unit 308 performs the specifying processing and updates the object table to reflect the result of the specifying processing. In step S806, based on the updated object table, the determination unit 314 determines whether all objects in the identifiable state are specified by the specifying unit 308. With reference to the identifiability determination 904 of each object in the object table 901, the determination unit 314 confirms whether the identifier 903 is already stored for the object of the identifiability determination “OK”. In other words, it is determined whether the all identifiable objects have been specified. If even one of the identifiable objects is not specified (NO in step S806), then in step S803, the determination unit 314 determines that the identification information is to be obtained to obtain the identification information corresponding to the object that has not been specified. Further, if the all identifiable objects have been identified (YES in step S806), then in step S807, the determination unit 314 determines that the identification information is not to be obtained as the identification information is not required, since even if new identification information is obtained, the object corresponding to the obtained identification information cannot be specified.

According to the example described above, if even one of the detected, identifiable objects is not specified, it is determined that the identification information is to be newly obtained, however, the determination is not limited thereto. For example, according to whether the result of the specifying processing satisfies a predetermined condition, it may be determined whether the identifier is to be obtained. As a specific example of the predetermined condition, the predetermined condition may be based on the number of the specified (non-specified) objects. Further, the predetermined condition may be based on the region of the specified object on the image to determine whether the identification information is to be newly obtained.

If the number of the specified objects is more than a predetermined value (e.g., five), it may be determined that the identification information may not be newly obtained since there is no more space on the image for newly displaying the information even if more objects can be newly specified. Further, based on a ratio of the number of the specified (non-specified) objects relative to that of the detected objects, it may be controlled not to obtain the identification information. For example, when the objects can be specified at the ratio of more than 80% of the detected objects, it may be determined that the identification information is not to be newly obtained for purpose of effective use of the power and the communication resources of the apparatus. Furthermore, when the region of the specified object on the image exceeds a predetermined value (e.g., equal to or more than 50% of the entire region of the captured image), it may be determined that the identification information is not to be newly obtained since there is no more space on the image for newly displaying the information even if the object can be newly specified. In other words, even if a part of the detected object is not specified, it may be controlled not to newly obtain the identification information.

When the above-described determination processing ends, the processing returns to FIG. 14. If the determination result by the determination unit 314 determines that the identification information is not to be obtained (NO in step S1412), the processing proceeds to step S1413. If the determination result determines that the identification information is to be obtained (YES in step S1412), the processing proceeds to step S1414. In step S1413, the wireless-communication control unit 301 controls not to obtain the identification information based on the determination result by the determination unit 314. Subsequently, the processing returns to step S1406 to display the attribute information corresponding to the specified object. In step S1413, the wireless-communication control unit 301 performs control not to transmit the probe request frame so as not to request the identification information from the surrounding terminals. Moreover, the wireless-communication control unit 301 controls a reception circuit of the wireless communication unit 1304 not to activate so that the terminal apparatus does not receive the signals for periodically notifying the wireless communication unit 1304 of the identifier. As described above, when the all object corresponding to the identification information about the terminal apparatus existing in the imaging range of the camera 101 has been specified, the wireless-communication control unit 301 does not request unnecessary identification information to be transmitted from the surrounding terminal apparatus. Therefore, since a usage of the unnecessary communication resources when the surrounding terminal apparatus transmits the identifier in response to the request can be reduced, the communication resources can be used effectively. Further, since a reception circuit of the wireless communication unit 1304 is controlled not to be activated so that the terminal apparatus does not receive the signals for periodically notifying the terminal apparatus of the identifier to contribute to energy saving of the camera 101.

On the other hand, in step S1414, if it is determined that the identification information is to be obtained, the identification-information obtaining unit 305 controls the wireless-communication control unit 301 to broadcast the probe request frame to obtain not-yet-obtained identification information about the terminal apparatus existing in the enabled communication area. At this point, the wireless-communication control unit 301 generates the probe request frame including the information for instructing not to respond to the probe request frame for the terminal apparatus whose identification information has been already obtained. In other words, the wireless-communication control unit 301 performs control not to obtain the identifier again from another apparatus whose identifier has been already obtained. For example, as illustrated in FIG. 11, the wireless-communication control unit 301 transmits the information including the identification information (identifier) that has been already obtained in the region 1102 of the probe request frame. If the identification information about the own terminal is included in the received probe request, the terminal apparatus does not respond a response message (probe response) to the frame. As described above, since the terminal apparatus whose identification information has been already obtained is made not to transmit the identification information again, the usage of the unnecessary communication resources can be reduced.

Subsequently, in step S1415, similarly to step S1403, the characteristic-information obtaining unit 306 and the attribute-information obtaining unit 307 obtain the feature information and the attribute information that are associated with the obtained identification information, and store them. In step S1416, the processing is switched between a case where the camera 101 determines that the identification information is to be obtained based on the motion amount in step S1411 (determination processing illustrated in FIG. 8) and a case where the camera 101 does not determine so. If it is determined that the identification information is to be obtained based on the motion amount (YES in step S1416), the processing returns to step S1413 to detect and specify the object captured in a new imaging range. On the other hand, if it is determined that the identification information is to be obtained since the all identifiable objects in the captured image have not been specified (NO in step S1416), the processing proceeds to step S1417. In step S1417, the specifying unit 308 performs the specifying processing on the object that has not been specified with reference to the object table based on the newly obtained feature information. The processing returns to step S1406 and, in step S1406, the combining unit 310 combines the attribute information and the through-the-lens image in association with the object specified by the specifying unit 308 near the object, and the display control unit 304 performs control to display the combined image.

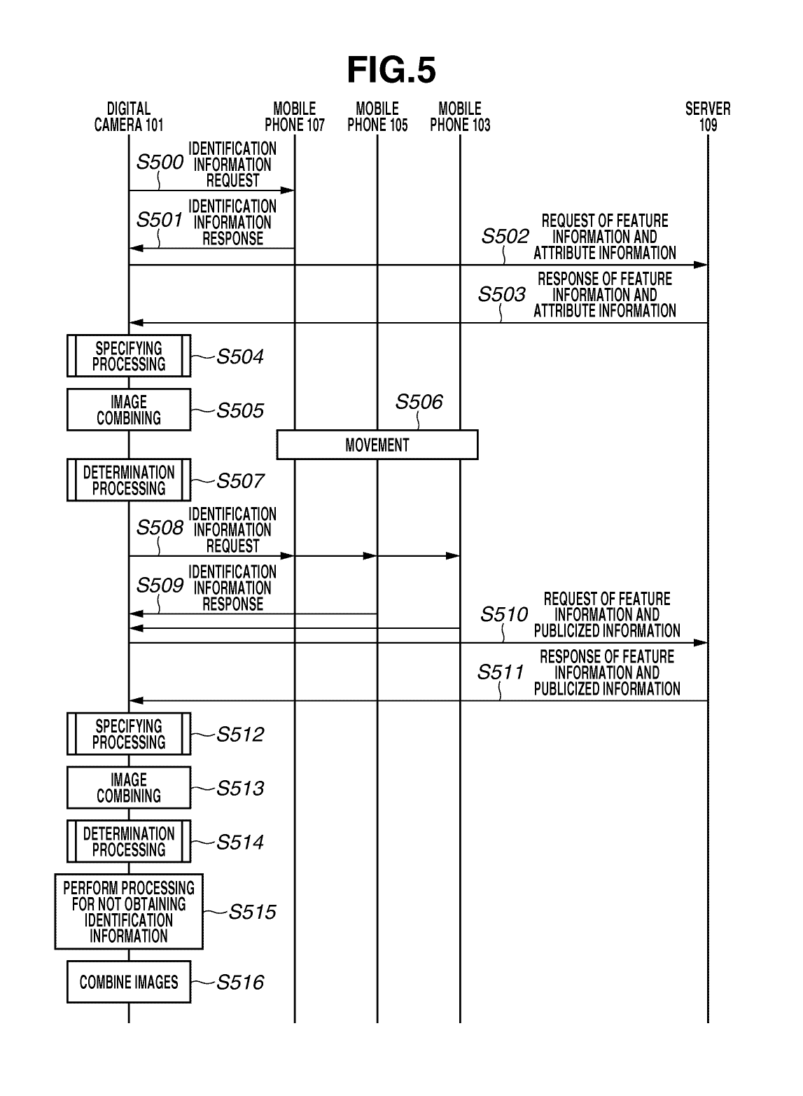

Subsequently, an operation of the system according to the present exemplary embodiment will be described. With reference to FIG. 5, a sequence will be described in which the object is specified when the camera 101 captures the images in a space where the persons 102, 104, and 106 exist as illustrated in FIG. 1, and the attribute information associated with the object is combined. FIG. 5 illustrates an example of a message sequence among the apparatuses in the AR system according to the present exemplary embodiment.

In steps S500, S1401, and S1402, if the shutter button 302 of the camera 101 is pressed or if the auto-obtaining unit 313 drives the identification-information obtaining unit 305, the identification information is requested from the terminal apparatus existing in the enabled communication area. In step S501, in response to the request from the camera 101, the mobile phone 107 existing in the enabled communication area transmits the identification information to the camera. Since the mobile phone 105 and the mobile phone 103 exist in a distance where the identification information request cannot be received from the camera 101 at this point, the mobile phone 105 and the mobile phone 103 do not transmit the identification information.

In step S502, the camera 101 requests the feature information and the attribute information from the server 109 based on the identification information received from the mobile phone 107. In steps S503 and S1403, the server 109 transmits to the camera 101 the characteristic information and the attribute information associated with the received identification information about the mobile phone 107. In steps S504, S1404, and S1405, the camera 101 detects the predetermined object from the current captured image, and determines whether the object that is specified based on the feature information associated with the mobile phone 107 exists in the detected object. In steps S505 and S1406, since the object corresponding to the identification information about the mobile phone 107 is specified from the through-the-lens image, the camera 101 associates the object and the attribute information to display thereof.

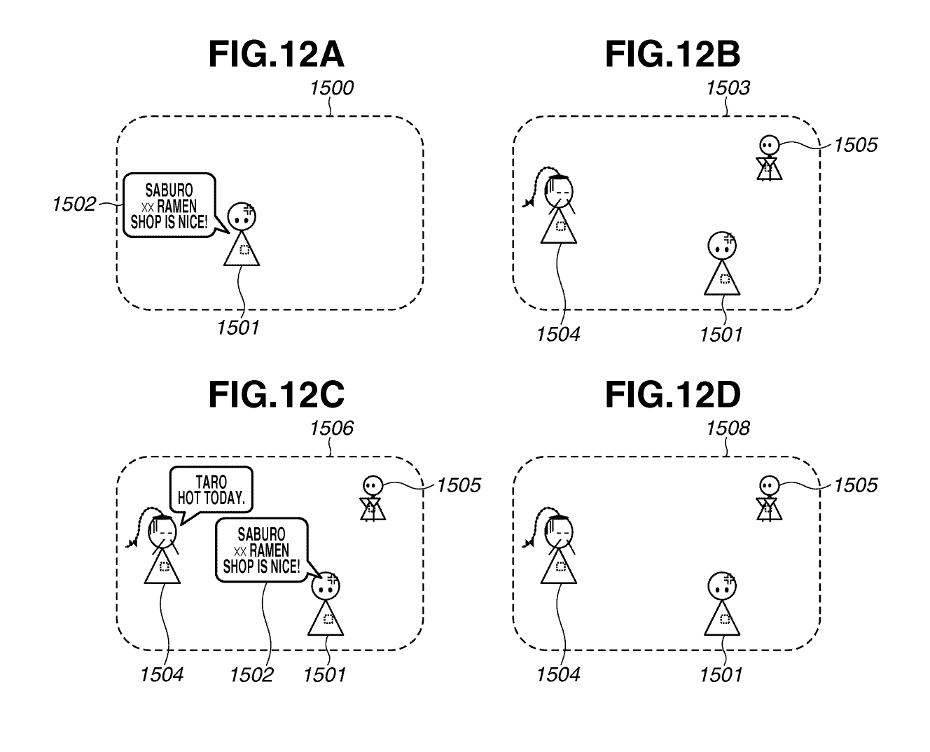

FIG. 12A illustrates an example of a display screen of the camera 101 in step S505. As illustrated in FIG. 12A, a display screen 1500 displays the through-the-lens image (a first captured image). An object 1501 is specified based on the feature information associated with the identification information about the mobile phone 107 and indicates a person 106. Attribute information 1502 is associated with the identification information about the mobile phone 107 and displayed in association with the specified object 1501. Since the persons 102 and 104 of the mobile phone 105 and mobile phone 103 do not exist in the image capturing area of the camera 101 at this point, they are not captured.

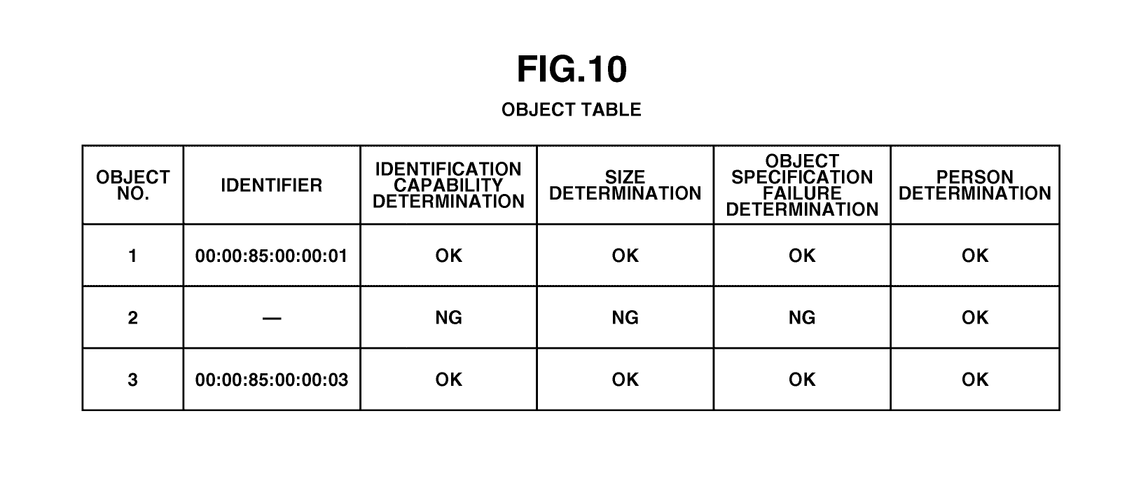

Subsequently, in step S506, the persons 102, 104, and 106 who are owners of the mobile phones move. If the shutter button 302 of the camera 101 is pressed again, or if the auto-obtaining unit 313 drives the identification-information obtaining unit 305, in steps S507, S1408, and S1409, the camera 101 starts the determination processing. FIG. 12B illustrates an example of the display of the through-the-lens image (a second captured image) when the determination processing is started. FIG. 9 illustrates the generated object table, and FIG. 10 illustrates the object table updated by the determination processing. FIG. 12B illustrates a display screen 1503. An object 1501 indicates the person 106, which is the object specified in step S504. An object 1504 that has been newly detected is the person 102, who is the owner of the mobile phone 103. An object 1505 that has been newly detected is the person 104, who is the owner of the mobile phone 105. In FIG. 12B, the attribute information is not displayed for the object 1501 (person 106), however, the attribute information may be continuously displayed for the specified object using the object tracking processing.

In the object table illustrated in FIG. 9, the person 102 is detected as “1” for the object number 902, the person 104 is detected as “2” therefor, and the person 106 is detected as “3” therefor. In the determination processing, based on the feature information used for the specifying processing performed on the through-the-lens image on the display screen 1500, the specifying processing is performed on the display screen 1503. The person 106 having the object number “3” can also be specified in the through-the-lens image displayed on the display screen 1503 based on the feature information that has been obtained and already owned.

Therefore, for the object number “3”, the column of the identifier 903 stores the identifier. However, for the object numbers “1” and “2”, since the identifier cannot be specified based on the feature information currently retained, the columns of the identifier 903 have no identifiers. Further, the object 1504 of the object number “1” is detected as the person and its size on the image is sufficiently large to perform the specifying processing, and thus “OK” is input in the identifiability determination 904. On the other hand, the object 1505 of the object number “2” is detected as the person, however, since it is determined that its size on the image is not sufficiently large to perform the specifying processing, “NG” is input for the identifiability determination 904. Since at least one of the detected objects has “OK” for the identifiability determination 904 and some objects have no identifiers for the identifier 903, then in step S803, the result of the determination processing is determined that identification information is to be obtained. In other words, since at least one non-specified object exists from among the detected objects, the result of the determination processing is determined that the identification information is to be obtained.

In step S508, the camera 101 performs the processing for obtaining the not-yet-obtained identification information about the terminal apparatus existing in the enabled communication area according to the determination for obtaining the identification information in step S507. More specifically, the wireless-communication control unit 301 transmits the probe request frame as illustrated in FIG. 11 by broadcasting. As illustrated in FIG. 11, a plurality of obtained identifiers is stored in a data portion to allow the probe request frame to be configured to have function to notify of the obtained identifier. The plurality of obtained identifiers may be stored. Further, the obtained identifiers may be divided into a plurality of probe requests to notify of. The identifier 00:00:85:00:00:03 of the mobile phone 107 indicated in FIG. 6 that is the obtained identifier by the camera 101 is appended to the probe request frame and transmitted. Since the mobile phone 107 recognizes the identifier of the own terminal in the received probe request, it does not respond.

In step S509, the mobile phones 103 and 105 each respond with the probe response frame to which the identification information illustrated in FIG. 6 is appended. Upon receiving the probe response frame, the camera 101 can obtain the identification information about the mobile phones 103 and 105. Upon obtaining the identification information by the identification-information obtaining unit 305, subsequently, in step S510, the camera 101 inquires at the server 109 about the feature information and the attribute information about the face of the person who transmits the identification information, more specifically the information about the person, using the feature-information obtaining unit 306 and the attribute-information obtaining unit 307. At this point, the identification information obtained in response to the inquiry is appended, so that the server 109 can determine whose information is to be obtained.

In step S511, upon receiving the information request about the person, the server 109 searches the attribute information and the feature information associated with the identification information from the database based on the received identification information, and then transmits thereof to the camera 101. In step S512, based on the obtained feature information, the camera 101 performs the specifying processing on each non-specified object. If the newly obtained object is successfully specified (YES in step S705), the object table is updated. Here, updated object table will be described with reference to FIG. 10.

FIG. 10 illustrates a state where the object 1504 of the object number “1” is specified by the specifying processing based on the newly obtained identification information, and then the identifier is assigned. In step S513, after the above-described processing is performed, the camera 101 combines the attribute information corresponding to the specified object obtained from the server 109 with the image data, and then the display control unit 304 displays the combined image on the display unit 1305. FIG. 12C illustrates an example of the display screen displayed in step S513, and also illustrates a display screen 1506, attribute information 1507 about the object 1504 (person 102). As illustrated in FIG. 12C, the attribute information can be displayed.

In step S514, the camera 101 starts the determination processing by the detection of pressing of the shutter button 302 or the notification of the auto-obtaining unit 313. FIG. 12D illustrates an example of the display screen when the determination processing is started in step S514. In FIG. 12D, the attribute information is not displayed with the object 1501 (person 106) and the object 1504 (person 102), however, the attribute information may be continuously displayed with the plurality of through-the-lens images in association with the specified object using the object tracking processing as illustrated in FIG. 12C.

Since there is no change of the positional relationship between the objects and the through-the-lens image on the example of the display screen illustrated in FIG. 12B where the specifying processing has been performed previous time, the object table has no change from that illustrated in FIG. 10. Further, suppose the motion amount of the camera 101 is equal to or less that the predetermined value. The specifying processing is performed using the owned feature information (feature information used for the specifying processing performed on the captured image (FIG. 12B)). Subsequently, the identifiers are input for all objects of the identifiability determination “OK” of the camera 101 and the object has been specified, as the result of the determination processing, it is determined that the identification information is not to be obtained. In step S515, the camera 101 performs for not obtaining the identification information. The processing for not obtaining the identification information indicates that the camera 101 does not request the identification information from the surrounding terminals. Further, the camera 101 does not perform the reception processing for receiving the signals (e.g., beacon), which the terminal apparatus transmits to periodically notify the camera 101 of the identification information. In step S516, the attribute information about the specified object is combined with the image data obtained from the image-capturing function unit 303, and then the display control unit 304 displays the combined image.

As described above, according to the present exemplary embodiment, the captured object is specified, and in the AR system displaying the information corresponding to specified object combined with the specified object, the capability of the performance of the obtaining processing of the identification information is determined depending on the identification state of the object detected from the captured image. Therefore, when identification information collection is not required, the identification information is not collected, thereby reducing the usage of the unnecessary communication resources. Particularly, for example, in an environment where a number of terminal apparatuses for transmitting the identification information are used, the communication resources can be remarkably, effectively used. Further, since unnecessary information collection processing is not performed, the camera 101 can reduce the power consumption.

The information processing apparatus according to the present exemplary embodiment obtains an identifier of another apparatus and detects a predetermined object from a captured image. Based on the obtained identifier, feature information for specifying the predetermined object is obtained. A first specifying processing is performed on a first captured image using a first characteristic information, and a specifying processing is performed on a second captured image using the first characteristic information used for the first specifying processing. Depending on a result of a second specifying processing, it is controlled not to obtain the identifier.

### Another Exemplary Embodiment

As another configuration, the present invention may specify the person in a moving image not in a still image, and display the attribute information. In such a case, the present invention may be realized by each frame of the moving image being sequentially processed as the still images.

The communication related to transmission and obtaining of the identification information may include Bluetooth and a radio-frequency identification device (RFID) of a passive/active type, in addition to the wireless LAN communication compliant with IEEE802.11. A plurality of wireless communication interfaces such as the wireless LAN and the RFID of passive type may simultaneously perform the communication for the identification information. A model of an obtaining request from the server is described for the identification information search, however the identification information search is not limited thereto and may be performed by a method of the identification information search in the own terminal.

Further, using the wireless method adopting a millimeter wave having directionality, the identification information may be transmitted and obtained. According to the exemplary embodiments, each identifier is associated with the person, however, it may be associated with an animal, a vehicle, or a certain specified object in addition to the person.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-089553, filed Apr. 10, 2012 which is hereby incorporated by reference herein in its entirety.

What is claimed is:

1. An information processing apparatus comprising:
an identifier obtaining unit configured to obtain an identifier of another apparatus;
a detection unit configured to detect a predetermined object from a captured image;
a feature-information obtaining unit configured, based on the obtained identifier, to obtain feature information for specifying the predetermined object;
a specifying unit configured, based on the feature information, to perform specifying processing for specifying the predetermined object detected by the detection unit; and
a control unit configured, depending on a result of the specifying processing, to perform control not to obtain the identifier by the identifier obtaining unit.

2. The information processing apparatus according to claim 1, wherein the control unit is configured, in a case where a part of the predetermined objects that have been detected is not specified by the specifying processing, to perform control to obtain the identifier by the identifier obtaining unit.

3. The information processing apparatus according to claim 2, wherein the specification unit, to specify the part of the predetermined objects that have not been specified, based on the feature information corresponding to the newly obtained identifier, is configured to perform the specifying processing.

4. The information processing apparatus according to claim 1, wherein the control unit is configured, in a case where all of the predetermined objects that have been detected are specified by the specifying processing, to perform control not to obtain the identifier by the identifier obtaining unit.

5. The information processing apparatus according to claim 1, wherein the control unit is configured, in a case where a part of the predetermined objects that have been detected are not specified by the specifying processing and in a case where the result of the specifying processing satisfies a predetermined condition, to perform control not to obtain the identifier by the identifier obtaining unit.

6. The information processing apparatus according to claim 5, wherein the predetermined condition is based on a size or a number of the predetermined objects that have been able to be specified.

7. The information processing apparatus according to claim 1, wherein the control unit is configured to perform control not to transmit to another apparatus a message for requesting the identifier so as not to obtain the identifier by the identifier obtaining unit.

8. The information processing apparatus according to claim 1, wherein the control unit is configured to perform control not to receive the identifier transmitted from another apparatus so as not to obtain the identifier by the identifier obtaining unit.

9. The information processing apparatus according to claim 1, further comprising a measurement unit configured to measure a movement of the information processing apparatus;
wherein the identifier obtaining unit is configured, in a case where the movement measured by the measurement unit exceeds a predetermined value, to obtain an identifier of another apparatus.

10. The information processing apparatus according to claim 1, wherein the identifier obtaining unit is configured not to obtain the identifier again from another apparatus whose identifier has been already obtained.

11. The information processing apparatus according to claim 1, wherein the identifier obtaining unit is configured to broadcast an identifier obtaining request including a message to another apparatus whose identifier has been already obtained for instructing not to respond.

12. The information processing apparatus according to claim 1, further comprising a display control unit configured to display predetermined information in association with a predetermined object specified by the specifying unit.

13. A control method of an information processing apparatus, the method comprising:
obtaining an identifier of another apparatus;
detecting a predetermined object from a captured image;
obtaining, based on the obtained identifier, feature information for specifying the predetermined object;
performing, based on the feature information, specifying processing for specifying the predetermined object detected by the detecting from a captured image; and
controlling, depending on a result of the specifying processing, not to perform the obtaining the identifier.

14. A computer-readable storage medium that stores a program for causing a computer to execute a control method according to claim 13.
